(19) United States
(12) Patent Application Publication
(10) Pub. No.: US 2013/0107436 A1
(43) Pub. Date: May 2, 2013

(54) POWER SUPPLY UNIT AND POWER SUPPLY SYSTEM FOR SERVERS

(71) Applicants: HAN-YU LI, Tu-Cheng (TW); NING ZHANG, Shenzhen City (CN); GUANG-DONG HE, Shenzhen City (CN)

(72) Inventors: HAN-YU LI, Tu-Cheng (TW); NING ZHANG, Shenzhen City (CN); GUANG-DONG HE, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/332,546

(22) Filed: Dec. 21, 2011

(30) Foreign Application Priority Data
Oct. 31, 2011 (CN) 201110337269.5

(51) Int. Cl. G06F 1/16

(52) U.S. Cl. 361/679.4

(57) ABSTRACT

A power supply unit for providing power to servers and a power supply system for servers is disclosed. The power supply unit for providing power to servers comprises a housing; power supplies assembled inside the housing, each of the power supplies comprising a first power supply array and a second power supply array, each of the power supplies in the first power supply array having a first output end and a second output end, each of the power supplies in the second power supply array having a third output end and a fourth output end; a circuit broad comprising a first, a second, a third and a fourth conductive plates, the first, the second, the third and the fourth conductive plates being electrically connected with the first, the second, the third and the fourth output ends, respectively; and an integrated management module electrically connected with the circuit broad.

### CROSS-REFERENCE TO RELATED APPLICATION

This patent application is related to a patent application, having Attorney Docket No. “US41054”, entitled “POWER SUPPLY UNIT AND POWER SUPPLY SYSTEM FOR SERVERS”, filed on the same date, assigned to the same assignee, and disclosure of which is incorporated herein by reference in its entirety.

### BACKGROUND

1. Technical Field

The disclosure generally relates to power supply units, and particularly relates to a power supply unit for providing power to servers and a power supply system for servers.

2. Description of Related Art

Each electrical device in servers employs an individual power supply cables to provide power for the servers. Therefore, each of the servers has to be equipped with a transformer and a rectification. The individual transformer and the individual rectification complicate structures of the servers. Having complicated structures inside the servers is not only hard to manage, but also inconvenient to maintain.

Therefore, a power supply unit is desired to overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a power supply unit in accordance with an embodiment of the present disclosure.

FIG. 2 is an exploded view of the power supply unit in FIG. 1.

FIG. 3 is an isometric view of the first to fourth conductive plates in FIG. 1.

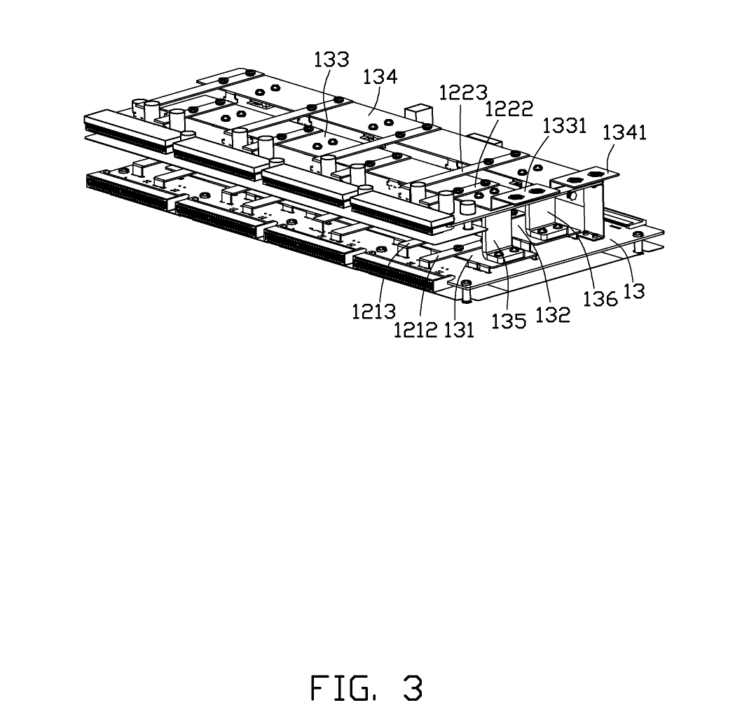

FIG. 4 is an isometric view of the power supply unit in FIG. 1 applied to a server cabinet.

FIG. 5 is an isometric view of a power supply device in FIG. 4.

FIG. 6 is an exploded view of a power supply device in FIG. 4.

### DETAILED DESCRIPTION

An embodiment of a power supply unit will be described with reference to the drawings.

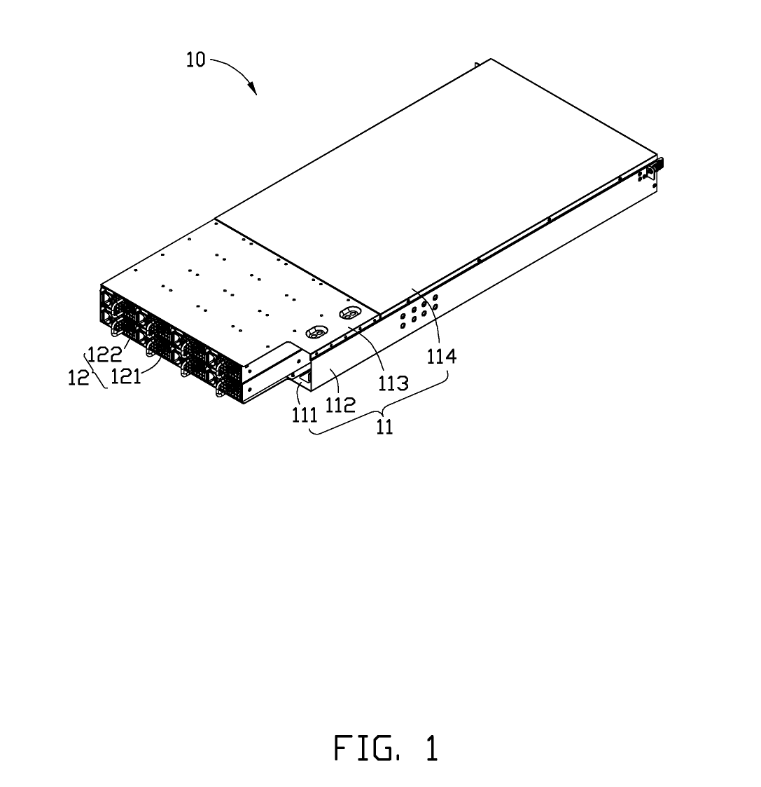

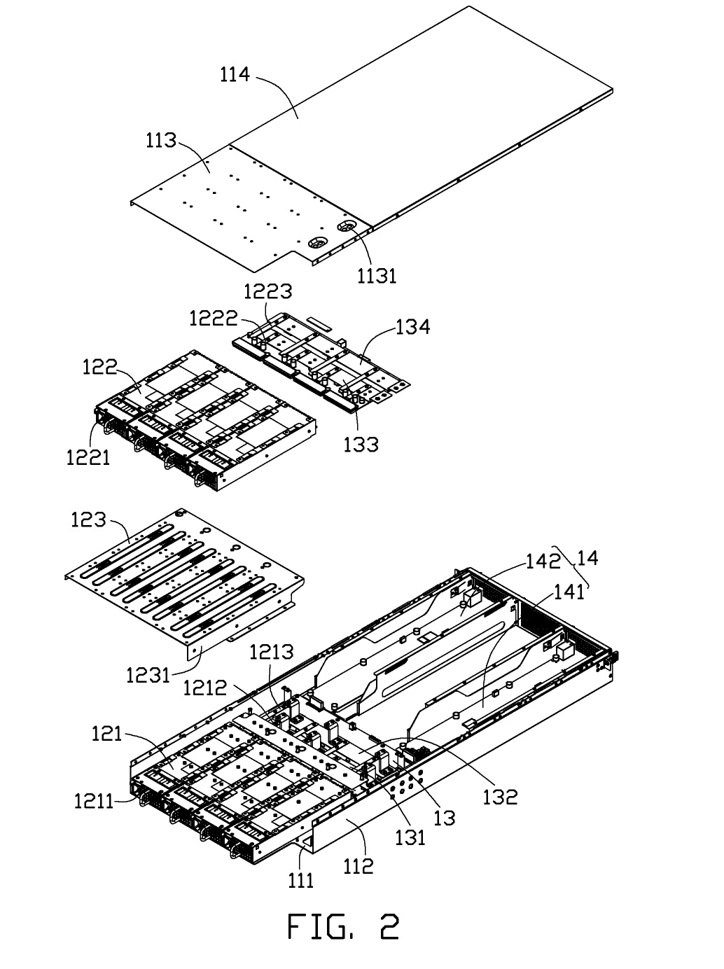

Referring to FIGS. 1-2, a power supply unit 10 for providing power to servers comprises a housing 11, a plurality of power supplies 12 assembled inside the housing 11, a circuit board 13 electrically connected with the plurality of power supplies 12, and an integrated management module 14 electrically connected with the circuit board 13.

The housing 11 is rectangular and comprises a bottom plate 111 and side walls 112. The bottom plate 111 and side walls 112 cooperatively define a receiving space for the plurality of power supplies 12, the circuit board 13, and the integrated management module 14. The circuit board 13 is positioned in the middle of the housing 11. The integrated management module 14 and the plurality of power supplies 12 are separately positioned at two opposite ends of the circuit board 13. The housing 11 further comprises a first cover plate 113 and a second cover plate 114. The first cover plate 113 is directly above the plurality of power supplies 12. The second cover plate 114 is directly above the circuit board 13 and the integrated management module 14. One end of the first cover plate 113 adjacent to the side walls 112 comprises two securing sections 1131.

The plurality of power supplies 12 comprise a first power supply array 121 and a second power supply array 122 overlapping the first power supply array 121. In this embodiment, a supporting plate 123 overlaps onto the upper surface of the first power supply array 121. Two lateral plates 1231 extend downwardly from the supporting plate 123 to secure the supporting plate 123 to the bottom plate 111. The second power supply array 122 is disposed on the supporting plate 123. The first power supply array 121 comprises a first input end 1211 electrically connected to an external power source(s). The first power supply array 121 receives a 220V AC voltage from the first input end 1211 and converts the 220V AC voltage into a 12V DC voltage. Output ends of the first power supply array 121 are electrically connected to the circuit board 13 by PCIE interfaces, and after integration by the circuit board 13, the 12V DC voltage is output between the first output end 1212 and the second output end 1213. The second power supply array 122 comprises a second input end 1221 for electrically connecting to the external power source(s). The second power supply array 122 receives a 220V AC voltage from the second input end 1221 and converts the 220V AC voltage into a 12V DC voltage. Output ends of the second power supply array 122 are electrically connected to the circuit board 13 by PCIE interfaces, and after integration by the circuit board 13, the 12V DC voltage is output between a third output end 1222 and a fourth output end 1223. In this embodiment, the plurality of power supplies 12 are arranged in a redundant array of N+N, wherein N is an integer greater than 1. N represents the number of the plurality of power supplies 12 assembled to meet the total power requirement of the servers. For example, if four of the plurality of power supplies 12 are necessary to meet the total power requirement of the servers, the total number of the plurality of power supplies 12 will be eight. In that case, when the first power supply array 121 is out of service, the remaining second power supply array 122 can still meet the power requirement of the servers.

The circuit board 13 is electrically connected to the plurality of power supplies 12 and the integrated management module 14. The circuit board 13 comprises a first conductive plate 131 and a second conductive plate 132 arranged parallel to the first conductive plate 131. The first output end 1212 of the first power supply array 121 is connected to the first conductive plate 131, and the second output end 1213 of the first power supply array 121 is connected to the second conductive plate 132. The first conductive plate 131 and the second conductive plate 132 are electrically connected to the servers, thereby providing power to the servers. The circuit board 13 further comprises a third conductive plate 133 and a fourth conductive plate 134 arranged parallel to the third conductive plate 133. The third output end 1222 of the second power supply array 122 is electrically connected to the third conductive plate 133. The fourth end 1223 of the second power supply array 122 is electrically connected to the fourth conductive plate 134. The third conductive plate 133 and the fourth conductive plate 134 are electrically connected to the servers, thereby providing them with power. The third conductive plate 133 overlaps onto the first conductive plate 131 and is electrically connected to the first conductive plate 131. The fourth conductive plate 134 overlaps onto the second conductive plate 132 and is electrically connected to the second conductive plate 132. A first supporting element 135 is formed between the first conductive plate 131 and the third conductive plate 133. One end of the first supporting element 135 is secured to the first conductive plate 131, and the other end of the first supporting element 135 is secured to the third conductive plate 133 thereby securing the third conductive plate 133 to the first conductive plate 131. The first supporting element 135 is metallic or made of metal to create an electrical connection between the first conductive plate 131 and the third conductive plate 133. Similarly, a second supporting element 136 is formed between the second conductive plate 132 and the fourth conductive plate 134 to secure the fourth conductive plate 134 to the second conductive plate 132. The second supporting element 136 is metallic or made of metal to create an electrical connection between the second conductive plate 132 and the fourth conductive plate 134. A lateral side of the third conductive plate 133 adjacent to the side walls 112 is bent upwards and a first connecting section 1331 extends from the third conductive plate 133 to the side walls 112. A lateral side of the fourth conductive plate 134 adjacent to the side walls 112 is bent upwards and a second connecting section 1341 extends from the fourth conductive plate 134 to the side walls 112. In this embodiment, the conductive plates 131 to 134 are all made of copper.

The integrated management module 14 is positioned at one end of the circuit board 13 opposite to the plurality of power supplies 12, to monitor the operational status of the plurality of power supplies 12. The integrated management module 14 can further comprise LED indicators to visually indicate the working conditions of the plurality of power supplies 12. In this embodiment, the integrated management module 14 comprises a first power management unit 141 and a second power management unit 142. The first power management unit 141 and the second power management unit 142 are positioned at two opposite sides of the front end of the power supply unit 10. Either one of the first power management unit 141 and the second power management unit 142 can monitor the operation of the plurality of power supplies 12 individually. If the first power management unit 141 fails, the second power management unit 142 can keep working without interrupting the power supplied to the servers. Similarly, if the second power management unit 142 fails, the first power management unit 141 can keep working without interrupting the power supplied to the servers.

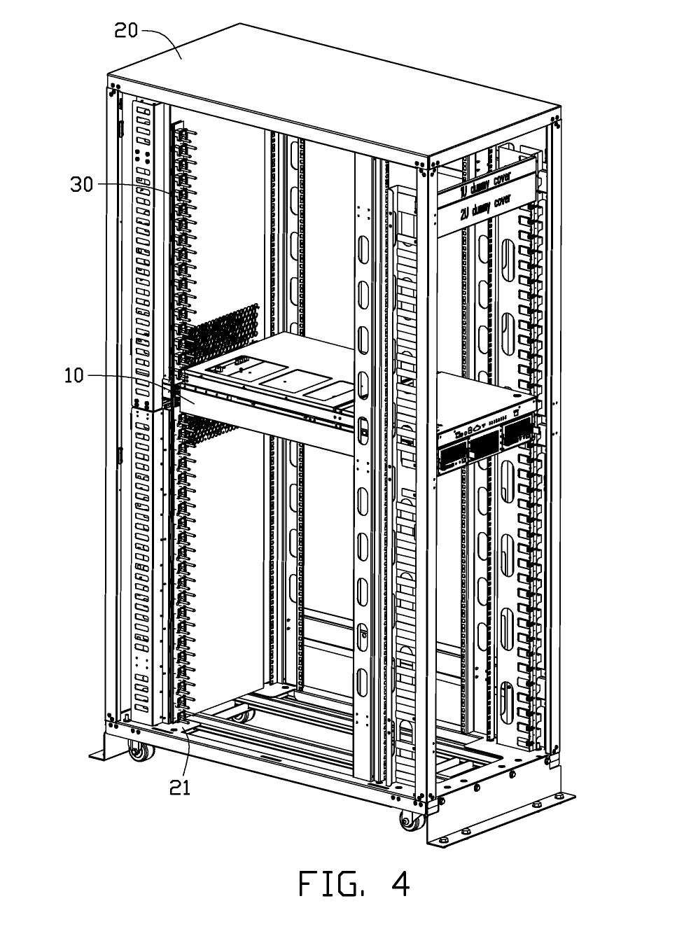

The power supply unit 10 can be applied to the power supply system of a server cabinet. Referring to FIG. 4, the power supply system for a server cabinet comprises a cabinet 20, the power supply unit 10 and a power supply device 30. A plurality of servers is positioned inside the cabinet 20. The power supply unit 10 provides power to the servers by virtue of the power supply device 30.

The cabinet 20 comprises a base 21. The power supply unit 10 is inserted into the cabinet 20 along a direction parallel to the base 21. In this embodiment, the power supply unit 10 is positioned in the middle of the cabinet 20. The servers can be positioned above or below the power supply unit 10. A height of the servers is about 1 U (44.45 mm) or 2 U in a dimensional classification. Similarly, a height of the power supply unit 10 is about 2 U, therefore the power supply unit 10 can be installed into any space which is available for a server in the cabinet 20.

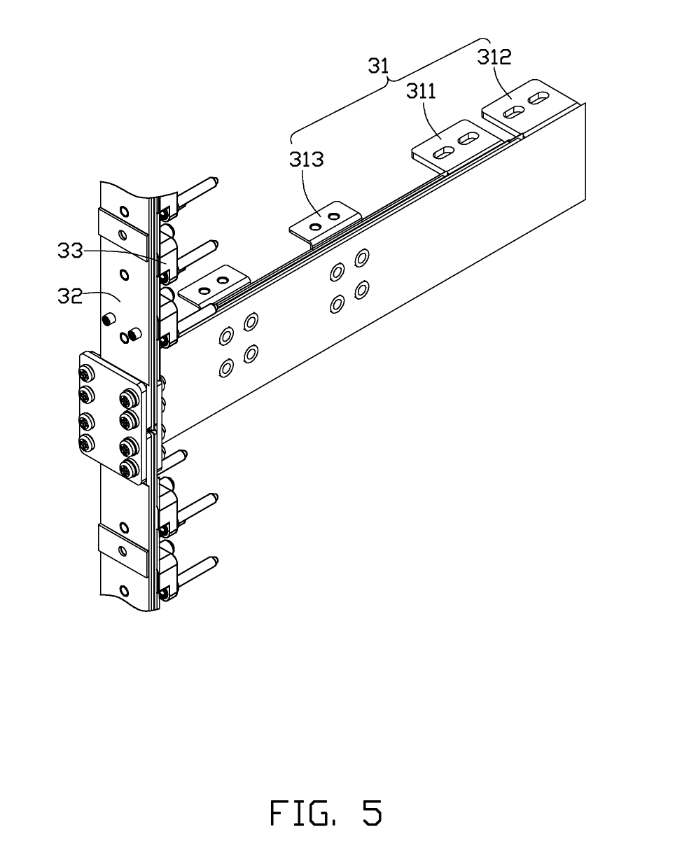

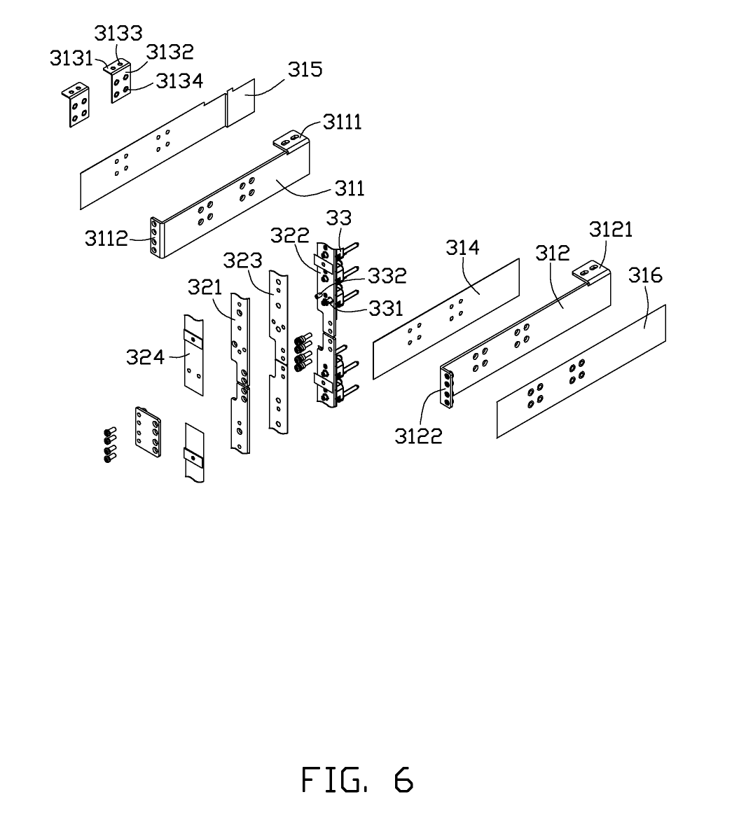

Referring to FIGS. 5-6, the power supply device 30 comprises a primary current conductive structure 31, a secondary current conductive structure 32 electrically connected to the primary current conductive structure 31 and a plurality of connectors 33.

The primary current conductive structure 31 comprises a first primary current conductive strip 311, a second primary current conductive strip 312 and a securing element 313 to connect the second primary current conductive strip 312 to the first primary current conductive strip 311. The first primary current conductive strip 311 and the second primary current conductive strip 312 are elongated copper strips. In this embodiment, the first primary current conductive strip 311 and the second primary current conductive strip 312 are plates attached to each other. The first primary current conductive strip 311 comprises a first current-guiding section 3111 and a first assembly section 3112. The first current-guiding section 3111 is electrically connected to the first conductive plate 131 and the third conductive plate 133. The second primary current conductive strip 312 comprises a second current-guiding section 3121 and a second assembly section 3122. The second current-guiding section 3121 is electrically connected to the second conductive plate 132 and the fourth conductive plate 134. The securing element 313 comprises a first securing plate 3131 and a second securing plate 3132. The first securing plate 3131 defines two first securing holes 3133 therein. Positions of the two first securing holes 3133 corresponds to positions of the two securing sections 1131 in the first cover plate 113. Therefore screws can be used to secure the first securing plate 3131 to the first cover plate 113. The second securing plate 3132 defines two second securing holes 3134, and the first primary current conductive strip 311 and the second primary current conductive strip 312 also define several securing holes (not shown), thereby enabling the connection of the first primary current conductive strip 311 and the second primary current conductive strip 312 to the second securing plate 3132. The primary current conductive structure 31 further comprises a spacer 314 formed between the first primary current conductive strip 311 and the second primary current conductive strip 312, thereby isolating the first primary current conductive strip 311 electrically from the second primary current conductive strip 312. A first insulating plate 315 is attached to an outer surface of the first primary current conductive strip 311 opposite to the spacer 314. A second insulating plate 316 is attached to an outer surface of the second primary current conductive strip 312 opposite to the spacer 314. By these means, neither the first primary current conductive strip 311 nor the second primary current conductive strip 312 is able to make electrical contact with the housing 11 of the power supply unit 10. In this embodiment, the first current-guiding section 3111 extends vertically from an upper section of the first primary current conductive strip 311, and the first assembly section 3112 extends vertically from a lateral section of the first primary current conductive strip 311. The second current-guiding section 3121 extends vertically from an upper section of the second primary current conductive strip 312, and the second assembly section 3122 extends vertically from an lateral section of the second primary current conductive strip 312.

The secondary current conductive structure 32 is secured in the cabinet 20 in a direction perpendicular to the base 21. The secondary current conductive structure 32 comprises a first secondary current conductive strip 321, a second secondary current conductive strip 322 and insulating element 323 and insulating element 324. In this embodiment, the first secondary current conductive strip 321 and the second secondary current conductive strip 322 are thin copper plates attached to each other. The first secondary current conductive strip 321 and the second secondary current conductive strip 322 are elongated copper strips. The first secondary current conductive strip 321 acts as a positive electrode and is electrically connected to the first assembly section 3112. The second secondary current conductive strip 322 acts as a negative electrode and is electrically connected to the second assembly section 3122. The insulating element 323 is formed between the first secondary current conductive strip 321 and the second secondary current conductive strip 322. The insulating element 324 covers a lateral side of the first secondary current conductive strip 321.

Each of the plurality of connectors 33 comprises a first pin 331 and a second pin 332. The first pin 331 is inserted into and electrically connected to the first secondary current conductive strip 321. The second pin 332 is inserted into and electrically connected to the second secondary current conductive strip 322. The plurality of connectors 33 are uniformly disposed on the first secondary current conductive strip 321 and the second secondary current conductive strip 322.

In use, the plurality of power supplies 12 output one or more DC voltages to the circuit board 13. The DC voltage(s) is integrated by the circuit board 13 and transmitted to the third conductive plate 133 and to the fourth conductive plate 134. Thereby, the DC voltage can be transmitted to the first primary current conductive strip 311 by the first conductive plate 131 and to the second primary current conductive strip 312 by the second conductive plate 132. Then the DC voltage can be transmitted to the first secondary current conductive strip 321 by the first primary current conductive strip 311 and to the second secondary current conductive strip 322 by the second primary current conductive strip 312. After that, the DC voltage is transmitted to the first pin 331 and to the second pin 332 of each of the plurality of connectors 33. The servers can obtain power from the secondary current conductive structure 32 by the plurality of connectors 33 because the first pin 331 and the second pin 332 of each of the plurality of connectors 33 are electrically connected to the servers. If any maintainance of the servers is required, it is only necessary to pull out the plurality of connectors 33 from the servers.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power supply unit for providing power to servers, comprising:
a housing;
a plurality of power supplies assembled inside the housing, each of the plurality of power supplies comprising a first power supply array and a second power supply array, each of the plurality of power supplies in the first power supply array having a first output end and a second output end, each of the plurality of power supplies in the second power supply array having a third output end and a fourth output end;
a circuit broad comprising a first conductive plate, a second conductive plate, a third conductive plate and a fourth conductive plate, the first conductive plate being electrically connected with the first output end, the second conductive plate being electrically connected with the second output end, the third conductive plate being electrically connected with the third output end, and the fourth conductive plate being electrically connected with the fourth output end; and
an integrated management module electrically connected with the circuit broad.

2. The power supply unit of claim 1, wherein the circuit broad is positioned in the middle of the housing, the integrated management module and the plurality of power supplies being positioned at two opposite ends of the circuit broad.

3. The power supply unit of claim 1, wherein the power supply unit is electrically connected with the circuit broad by Peripheral Component Interconnect Express (PCIe) interfaces.

4. The power supply unit of claim 1, wherein the integrated management module is electrically connected with the circuit broad by PCIe interfaces.

5. The power supply unit of claim 1, wherein the second power supply array is overlapping on the first power supply array.

6. The power supply unit of claim 1, further comprising a supporting plate overlapping on an upper surface of the first power supply array, the supporting plate is secured to a bottom plate of the housing by two lateral plates extending downwardly from the supporting plate, and the second power supply array being disposed on the supporting plate.

7. The power supply unit of claim 1, wherein a number of the plurality of power supplies, N, is determined by a total power requirement of the server, N being an integer greater than one; the plurality of power supplies are arranged in a redundant array of N plus N.

8. The power supply unit of claim 1, wherein the first conductive plate and the second conductive plate are paralleled to each other, the third conductive plate is positioned above the first conductive plate, and the fourth conductive plate is positioned above the second conductive plate.

9. The power supply unit of claim 8, further comprising a first supporting element between the first conductive plate and the third conductive plate, and a second supporting element between the second conductive plate and the fourth conductive plate, wherein the third conductive plate is secured on the first conductive plate by the first supporting element, and the fourth conductive plate is secured on the second conductive plate by the second supporting element.

10. A power supply system for servers, comprising:
a cabinet for receiving the servers, the cabinet having a base;
a power supply unit being received in the cabinet and parallel to the base, the power supply unit comprising:
a housing;
a plurality of power supplies assembled inside the housing, each of the plurality of power supplies comprising a first power supply array and a second power supply array, each of the plurality of power supplies in the first power supply array having a first output end and a second output end, each of the plurality of power supplies in the second power supply array having a third output end and a fourth output end;
a circuit broad comprising a first conductive plate, a second conductive plate, a third conductive plate and a fourth conductive plate, the first conductive plate being electrically connected with the first output end, the second conductive plate being electrically connected with the second output end, the third conductive plate being electrically connected with the third output end, and the fourth conductive plate being electrically connected with the fourth output end; and
an integrated management module electrically connected with the circuit broad; and
a power supply device adapted to provide power to the servers, the power supply device comprising:
a primary current conductive structure comprising a first primary current conductive strip and a second primary current conductive strip;
a secondary current conductive structure being secured in the housing and perpendicular to the base, the secondary current conductive structure comprising a first secondary current conductive strip and a second secondary current conductive strip, the first secondary current conductive strip being electrically connected with the first conductive plate and the third conductive plate through the first primary current conductive strip, and the second secondary current conductive strip being electrically connected with the second conductive plate and the fourth conductive plate through the second primary current conductive strip; and
a plurality of connectors adapted to electrically connecting the servers, each of the plurality of connectors comprising a first pin and a second pin, the first pin being inserted into and electrically connected with the first secondary current conductive strip, the second pin being inserted into and electrically connected with the second secondary current conductive strip.

11. The power supply system of claim 10, wherein the first primary current conductive strip and the second primary current conductive strip are plates attached to each other, and the first secondary current conductive strip and the second secondary current conductive strip are plates attached to each other.

12. The power supply system of claim 10, wherein the primary current conductive structure further comprises a spacer between the first primary current conductive strip and the second primary current conductive strip, the spacer is adapted to electrically insulate the first primary current conductive strip from the second primary current conductive strip.

13. The power supply system of claim 12, further comprising a first insulating plate attached to an outer surface of the first primary current conductive strip opposite to the spacer, and a second insulating plate attached to an outer surface of the second primary current conductive strip opposite to the spacer.

14. The power supply system of claim 10, wherein the secondary current conductive structure further comprising an insulating element positioned between the first secondary current conductive strip and the second secondary current conductive strip, the insulating element is adapted to electrically insulate the first secondary current conductive strip from the second secondary current conductive strip.

15. The power supply system of claim 10, wherein the plurality of connectors are disposed at one side of the secondary current conductive structure at a uniform interval.

16. The power supply system of claim 10, wherein the first primary current conductive strip comprises a first current-guiding section and a first assembly section, the first current-guiding section is electrically connected with the first conductive plate and the third conductive plate, the first assembly section is electrically connected with the first secondary current conductive strip; the second primary current conductive strip comprises a second current-guiding section and a second assembly section, the second current-guiding section is electrically connected with the second conductive plate and the fourth conductive plate, and the second assembly section is electrically connected with the second secondary current conductive strip.
